(19) United States
(12) Patent Application Publication
(10) Pub. No.: US 2023/0162261 A1
(43) Pub. Date: May 25, 2023

(54) CONVERSATIONAL PERSUASION SYSTEMS AND METHODS

(71) Applicant: ZOOVU Limited (UK), London (GB)

(72) Inventors: Jonathan TAYLOR, Houston, TX (US); Michal DUDA, Wroclaw (PL); Monika SZYMANSKA, Pisarzowice (PL); Ilir OSMANAJ, Wien (AT); Marinos ILIADIS, Vienna (AT); Filip DRATWINSKI, Zielona Góra (PL); Marcin KORALEWSKI, Slupsk (PL); Gent REXHA, Vienna (AT)

(21) Appl. No.: 17/988,882

(22) Filed: Nov. 17, 2022

Related U.S. Application Data
(60) Provisional application No. 63/264,541, filed on Nov. 24, 2021.

(51) Int. Cl. G06Q 30/06; G06Q 30/02; G06F 40/30

(52) U.S. Cl. CPC G06Q 30/0631; G06Q 30/0282; G06F 40/30

(57) ABSTRACT

Disclosed embodiments relate to conversational persuasion systems, methods, and non-transitory computer-readable storage mediums that are aimed to provide pertinent product recommendations and mimic the benefits of in-person interactions via an online assistance platform. The disclosed embodiments leverage the data processing power of computing devices while still providing customers with a productive online conversation that provides responses to customers based on historical and current information. The disclosed embodiments analyze the information using a model that applies one or more weights to the information and selects responses to present to the customer. The responses provided increase the likelihood of a customer purchase or another customer event.

### PRIORITY

The present application claims priority to U.S. Provisional Patent Application No. 63/264,541, filed Nov. 24, 2021, the disclosure of which is incorporated herein by reference in its entirety.

### TECHNICAL FIELD

The present disclosure is generally related to systems and methods for enhanced product recommendations and online assistant interactions. More specifically, and without limitation, this disclosure relates to computer-implemented systems and methods for virtually interacting with a customer to provide persuasive and relevant product recommendations. The systems and methods disclosed herein may be used in various applications, such as online stores, kiosks, and/or web-based chat functions.

### BACKGROUND

For in-person sales interactions, a salesperson typically proposes questions to a consumer to assess the consumer's needs and determine an appropriate product recommendation. For example, when making a recommendation, a salesperson may take into account observations made by the salesperson regarding the customer that may be objective and subjective, and the salesperson's personal knowledge. It is difficult to replicate a sales interaction in a virtual environment because there is often no effective method to identify and relate subjective observations to objective responses and provide a relevant and useful recommendation or information to a virtual consumer. While a good recommendation can sometimes be derived solely from objective attributes of a product, the relation between the subjective and the objective can sometimes be ambiguous and nontrivial to derive. Thus, there is a need for a system that assesses both the subjective and the objective indicia to recommend relevant products and/or information to a consumer in a virtual environment.

### SUMMARY

Consistent with the present disclosure, there is provided a system for providing information to a customer to increase a likelihood of a purchase. The system comprises: at least one processor programmed to: receive at least one response from the customer; analyze the at least one response to determine contextual information associated with the at least one response; access a database to select a product category identifier based on the contextual information; analyze, using a model, the contextual information and the product category identifier to generate a plurality of outputs, wherein the model is configured to apply one or more weights to the contextual information and the product category identifier; select one of the plurality of outputs; and provide the selected output to the customer.

Consistent with the present disclosure, there is provided a method for providing information to a customer to increase a likelihood of a purchase. The method comprises: receiving at least one response from the customer; analyzing the at least one response to determine contextual information associated with the at least one response; accessing a database to select a product category identifier based on the contextual information; analyzing, using a model, the contextual information and the product category identifier to generate a plurality of outputs, wherein the model is configured to apply one or more weights to the contextual information and the product category identifier; selecting one of the plurality of outputs; and providing the selected output to the customer.

Consistent with the present disclosure, there is provided a non-transitory computer-readable storage medium storing instructions that, when executed by at least one processor, cause the at least one processor to perform a method for providing information to a customer to increase a likelihood of a purchase. The method comprises: receiving at least one response from the customer; analyzing the at least one response to determine contextual information associated with the at least one response; accessing a database to select a product category identifier based on the contextual information; analyzing, using a model, the contextual information and the product category identifier to generate a plurality of outputs, wherein the model is configured to apply one or more weights to the contextual information and the product category identifier; selecting one of the plurality of outputs; and providing the selected output to the customer.

The foregoing general description and the following detailed description are exemplary and explanatory only and are not restrictive of the claims.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 illustrates a schematic diagram of a system for providing information to a customer according to a disclosed embodiment.

FIG. 2A illustrates a chat-based persuasive recommendation according to a disclosed embodiment.

FIG. 2B illustrates a chat-based persuasive recommendation with an alternative suggestion according to a disclosed embodiment.

FIG. 3 illustrates a block diagram of a recommendation engine for a persuasive statement determination according to a disclosed embodiment.

FIG. 4 illustrates a method for generating and outputting an optimal response according to a disclosed embodiment.

FIGS. 5A and 5B illustrate a system stack of a persuasive recommendation system according to a disclosed embodiment.

FIG. 6 illustrates a prediction model using a Deep Q Network (DQN) approach to persuasive recommendation according to a disclosed embodiment.

FIG. 7 illustrates a prediction model using a Dueling DQN approach to persuasive recommendation according to a disclosed embodiment.

FIG. 8A illustrates a recommendation engine with a determined best single classification engine from three classification engines according to a disclosed embodiment.

FIG. 8B illustrates a recommendation engine with a determined best combination classification engine from three classification engines according to a disclosed embodiment.

FIG. 9A illustrates a visual classification recommendation according to a disclosed embodiment.

FIG. 9B illustrates a visual classification recommendation according to another disclosed embodiment.

FIG. 10 illustrates Fast Classification and Optimal Classification training and recommendation according to a disclosed embodiment.

FIG. 11A illustrates a generic product ontology with subcomponents according to a disclosed embodiment.

FIG. 11B illustrates a bicycle product ontology with subcomponents according to a disclosed embodiment.

FIG. 12 illustrates a human-assisted training graphical user interface (GUI) according to a disclosed embodiment.

FIG. 13 illustrates a diagram of a visual training engine according to a disclosed embodiment.

FIG. 14 illustrates a diagram of a natural language processing (NLP) training engine according to a disclosed embodiment.

FIG. 15 illustrates a visualization of an NLP classification engine according to a disclosed embodiment.

### DETAILED DESCRIPTION

Some embodiments are directed to a needs-based conversation optimizer, wherein a system is constructed and configured to recommend products or provide useful responses based on a customer's needs and stored information. In-person sales interactions largely depend on both objective and subjective goals, communicated by a customer and assessed by a salesperson, who recommends a product or provides a response. For example, if a consumer is looking for a new computer, the consumer may communicate that she needs objective goals, such as “I need an i7 processor,” “I need a dedicated GPU,” “I want to pay less than $1,000,” or “I would like a Dell.” These objective goals are generally binary and allow for simple narrowing of a range of recommended products. The customer may also communicate subjective goals, however, which are sometimes harder to quantify. Subjective needs often vary widely from customer to customer. For example, if a customer communicates she wants a “highly portable computer,” this may rely on many objective factors, such as “battery capacity,” “typical run time,” “weight,” “size,” “screen brightness,” etc. When building systems to handle sales online, systems generally have not taken an effective approach to assessing the objective and subjective factors.

In the prior art, systems have established rules-based models for products. For example, “portability” may be defined as being less than 2 pounds, a “bright screen” may be defined as greater than 400 nits, and a mid-size computer may be defined as less than 15 inches. The problem with this approach is that it reduces subjective attributes to binary attributes, even though they often are nonbinary in nature. For example, a laptop may not be characterized as portable or unportable but instead according to a continuous scale that can often depend—in some part—on personal preference. In addition, the rules-based approach becomes increasingly complex once each individual feature is considered in relation to another. For example, a laptop may be more “portable” when it includes less or smaller components making it weigh less, but this sacrifices performance such as battery life because a smaller battery may be used. These relationships and features are complex and sometimes almost impossible to effectively model via rules. Further, as products, tastes, and demands change, the rules also change. However, it may not be possible to adapt the rules to meet constantly evolving and improving criteria. For example, a product may become more efficient or lighter, or become more or less fashionable. It may not be possible to adapt the rules to such situations. The present embodiments address these problems by using a combination of unique training models and recommendation engines to suggest a product to a virtual consumer that is both relevant and effective, and likely to produce an eventual sale.

Embodiments disclosed herein solve the above problems by leveraging historical and real-time information to provide enhanced and tailored recommendations and/or responses to a user. More particularly, in some embodiments, a system is operable to evaluate both objective and subjective attributes, and—based on previous interactions—develop a machine learning module for recommending relevant products. Some embodiments use a combination of visual, textual, and human-aided training to enhance the module performance and effectiveness. In some embodiments, the system further determines which recommendations or responses have the highest probability of leading to a sales conversion or some other desired result. In some embodiments, the system further generates key phrases or descriptions based on a machine learning model and/or received customer inputs, wherein the system is operable to determine which key phrases or descriptions will result in the highest probability of a sales conversion or some other desired result.

Reference will now be made in detail to exemplary embodiments, discussed with regard to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments. Similarly, additional steps may be added or steps may be removed without departing from the envisioned embodiments. Thus, the materials, methods, and examples are illustrative only and are not intended to be necessarily limiting. All figures discussed herein are to be interpreted inclusively, meaning that aspects of one or more figures may be combined with aspects of any one or more other figures.

### I. Responses

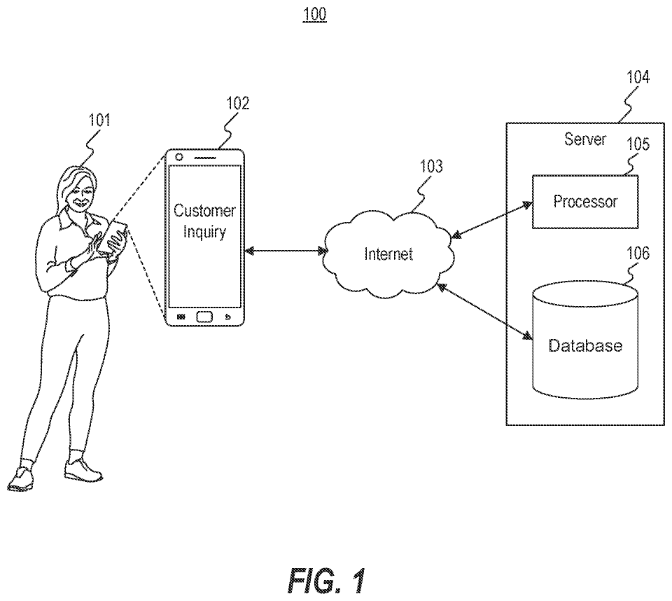

FIG. 1 illustrates a schematic diagram of a system 100 for providing information to a customer, according to disclosed embodiments. In the illustrated embodiment, the system 100 includes a Graphical User Interface (GUI) on a user device 102 that is operable to receive a customer inquiry from a user 101. Some examples of the user device 102 include a mobile phone, tablet, and computer. The customer inquiry can be made on an internet-based application on the mobile device. For example, the user 101 of the user device 102 can open a web browser or software program that displays content on the GUI. The software program may be downloaded onto the user device 102 as an application. The content displayed on the GUI may permit the user 101 to enter the customer inquiry. The user device 102 is operable to communicate the customer inquiry to a server 104 over the internet 103. The user device 102 has a network connection that permits it to communicate with various devices over the internet 103 such as the server 104. The server 104 may contain various components including, but not limited to, a processor 105 and a database 106. The processor 105 is operable to perform various functions in response to the server 104 receiving the customer inquiry. In some embodiments, the server 104 is operable to store models, products, classifications, predetermined responses, and other relevant attributes in a local or remote database. For example, the database 106 is operable to store various information, such as environmental parameters related to customer inquiries and/or customers; parameters relating to the customer including customer behavior, customer demographics, and previous customer inquiries; and parameters relating to other customers including customer behavior of the other customers, demographics of the other customers, previous inquiries from the other customers, and previous actions of the other customers. Environmental factors include time, date, and location related to the customer inquiry and/or customer. The database may also include other information such as product information including, but not limited to, inventory data and product trend data.

In some embodiments, the processor 105 is operable to receive customer inquiries from customers over the internet 103 and evaluate the customer inquiry to extract inquiry data based on the content of the customer inquiry. The processor 105 is further operable to access the database 106 to retrieve stored information associated with the customer inquiry. The processor 105 may be further programmed to select a product category identifier based on the retrieved data and the customer inquiry. For example, the customer inquiry may indicate that a customer is interested in purchasing cameras, and the processor may be configured to retrieve stored information in the database 106 related to the cameras. The processor 105 may be further operable to use a model to analyze the pertinent information retrieved from the database 106 and the inquiry data to generate one or more possible outputs to provide to the customer in response to the customer inquiry. The processor 105 may further be operable to select an output and provide it to the customer on the GUI of the user device 102.

Based on the models developed and stored in the server 104, responses generated by the server 104 are designed and determined to increase likelihood of a predetermined action by the customer. For example, if the server 104 includes a predetermined goal of increasing sales, the system 100 is operable to generate and produce a response determined to have the greatest likelihood of sales conversion. In some embodiments, the likelihood of success is determined based on classification algorithms disclosed herein.

Similar to in-person sales interactions, not only are products that match the objective needs of a customer determined, but inquiries are made to the customer about subjective attributes, and persuasive statements are provided to the customer that result in a sale. Some embodiments accomplish this by determining attributes, textual descriptions, and key phrases that may be particularly relevant to a determined need and providing these statements in a customer response. For example, in some embodiments, the system 100 is operable to recommend a product based on the classification and ontology attached to each individual product. In some embodiments, the system 100 is operable to receive an input from the customer via a GUI, and, based on the input, determine a response that maximizes a set outcome. For example, in one embodiment, the system 100 receives a chat-based input from a consumer, wherein the consumer says, “I am looking for a lamp that is ergonomic.” The system 100 is operable to extract the terms “lamp” and “ergonomic” from the customer input based on models developed through classification procedures. Then, based on these models and classification procedures, the system 100 is operable to serve or provide to the customer with an identity of each of the products classified as “lamp” and “ergonomic.” If the customer eventually makes a selection and/or a purchase, the system 100 is operable to store the selection and/or purchase and update the model based on the purchase. In one embodiment, if a product is selected and not purchased, or if a product is not selected from a served list of products, the system 100 is further operable to store that interaction data and update the model accordingly. For example, if a lamp is served but not selected, the system 100 is operable to reduce a correlation value of the product for classification of “ergonomic,” which will have the effect of reducing the frequency of the product being suggested, the order it is suggested, or whether the product is suggested at all. In some embodiments, the system 100 is operable to develop a model for a particular customer, wherein the customer's choice to purchase or not purchase a product adjusts a personal correlation value to a product, but does not affect the correlation value for other customers. In this way, if one customer's definition of what is “ergonomic” differs from another's definition, the system is still operable to serve a product that has the highest likelihood of eventual purchase across multiple customers.

In some embodiments, the system 100 is operable to determine a valuable product feature for one or more products. For example, in some embodiments, the system 100 is operable to train and/or use a trained model with visual, textual, or other attributes that correlate to a valuable product feature. This includes, in some embodiments, determining that a specific feature is present across multiple structured and unstructured product information, such as a design that is expensive to produce, fashionable, or otherwise valuable to a consumer. Based on one or more determined value product feature, the system 100 is operable to recommend a product to a customer based on a determined increase in revenue or profit. For example, if two products are equally correlated to a specific inquiry, the system 100 is operable to factor in the valuable product information to ultimately recommend a product that has an increased profit margin. In some embodiments, the system 100 is operable to determine a set of products that correlate to a specific classification and/or customer inquiry. In some embodiments, the system 100 is operable to train a model based on a first subset of the product set. Based on a training via visual, textual, or human-aided inputs, the system 100 is operable to recognize a valuable product feature and extrapolate that determination to a second subset of the product set to identify the valuable product feature in additional products. In some embodiments, the valuable product feature is based on a manually or automatically preset value (e.g., a product that has a 20% mark-up in price or over a $100 value). In some embodiments, the valuable product feature is indicated by the system 100 as determining a consistent feature across products with a higher average price than the product set as a whole.

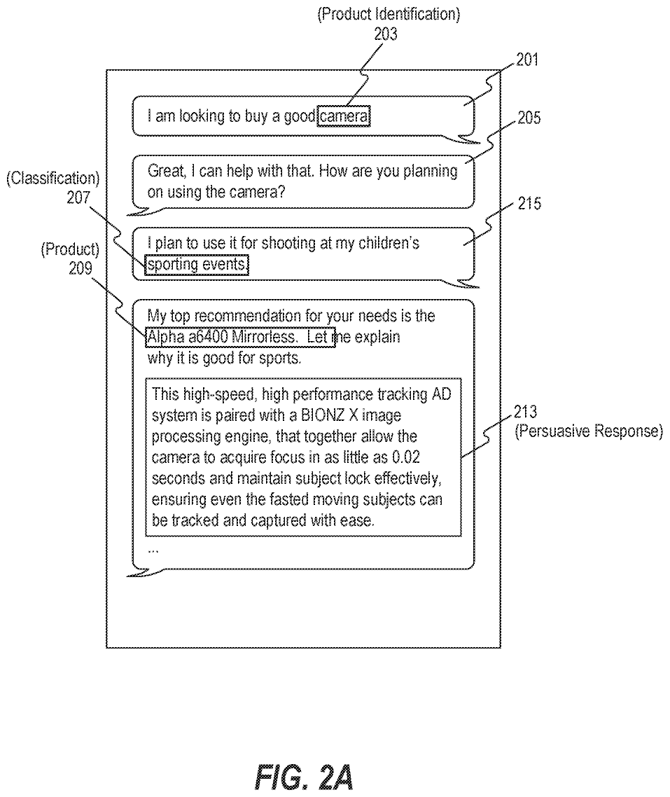

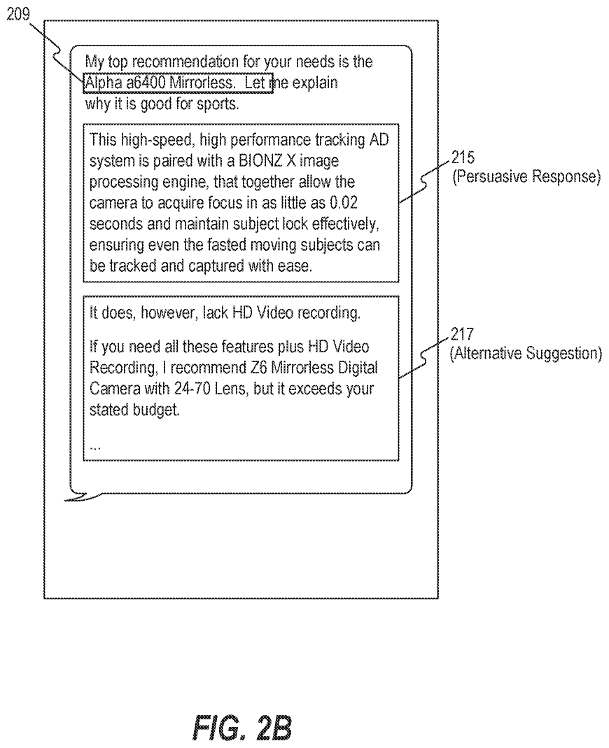

In some embodiments, the system 100 is operable to generate optimal responses based on the input by the user 101 that are directed toward improving the likelihood of success in generating a specific action by the user 101. For example, FIG. 2A illustrates a chat-based persuasive recommendation according to a disclosed embodiment. Particularly, FIG. 2A depicts an embodiment that provides a response for a camera product. In the illustrated embodiment, a customer inquiry 201 includes a product identification 203. The system 100 is operable to analyze semantics of the inquiry 201 and determine a presence and type of the product identification 203, which in the illustrated embodiment is a camera. The system 100 is operable, in some embodiments, to then issue a response 205 for additional classification information based on the product identification 203. For example, in some embodiments, the system 100 is operable to extract a product identification of “camera” and determine that camera has multiple classifications, including sports, active, filming, etc. The system 100 is operable to query for a relevant user classification. In the illustrated embodiment, after generating a response 205 to prompt the customer for a relevant classification, the system 100 further receives a classification 207. Based on the classification 207, the system 100 is operable to query and determine at least one relevant product (e.g., a product that has a highest correlation value to the specific inquiry), and the system 100 is further operable to then provide a product recommendation 209 based on classification 207. In some embodiments, the system 100 receives multiple classifications. In some embodiments, the system is further operable to receive another customer inquiry 215 and/or serve a persuasive response 213, wherein the persuasive response 213 is a description associated with the at least one relevant product, the classification, and/or a subclassification. In some embodiments, the system 100 includes multiple persuasive responses 213, and the system 100 is operable to determine a response most likely to result in a sales conversion, wherein the likelihood of a sales conversion is determined based on past system interactions, inputs from a specific customer, and/or a correlation of the persuasive response to specific needs or products communicated via input by a customer.

FIG. 2B illustrates a chat-based persuasive recommendation with an alternative suggestion, according to a disclosed embodiment. In some embodiments, the system 100 is operable to provide an alternative chat-based recommendation response based on a determined next-best product. For example, in the embodiment illustrated in FIG. 2B, the system 100 provides a first persuasive response 215, and an alternative suggestion 217, wherein the alternative suggestion 217 is a close match with at least one classification that does not highly correlate with the customer inquiry and/or wherein a total correlation value is high, but the product does not meet at least one objective criterion provided by the customer inquiry. In other embodiments, the system 100 generates multiple responses but only provides one of the responses based on a confidence value. For example, the response provided may have the highest or second-highest confidence value. In some embodiments, the response provided is based on the system 100 implementing a randomness alpha variable to the confidence values determined for each generated response. For example, the confidence value for each generated response may randomly be multiplied by a value between 0 and 1, and the response provided may be selected based on the highest confidence value after implementing the randomness alpha variable.

In some embodiments, the system is operable to use a recommendation engine to provide a comparison between products. For example, if two products are highly correlated to a consumer's needs, the system 100 is operable to use the recommendation engine to deliver key statements that differentiate the two products. For example, if one camera is mirrorless and the other is not, the system 100 is operable to extract and provide statements that describe a mirrorless camera and its advantages or disadvantages (in general or for a specific customer inquiry).

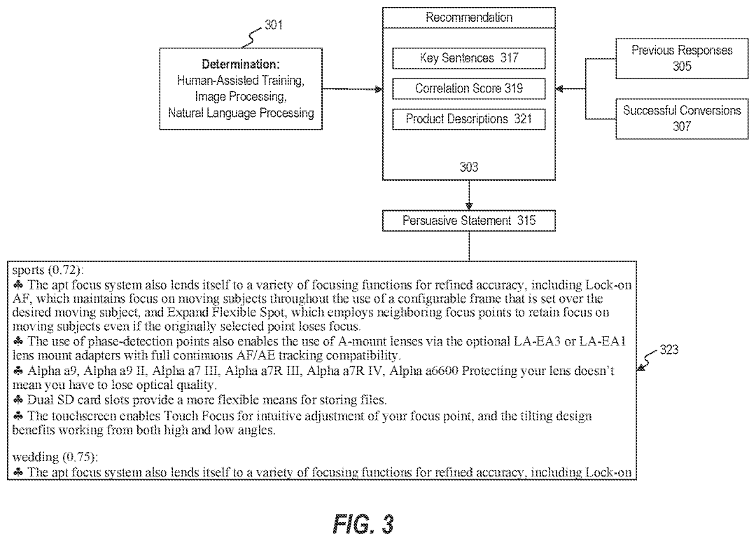

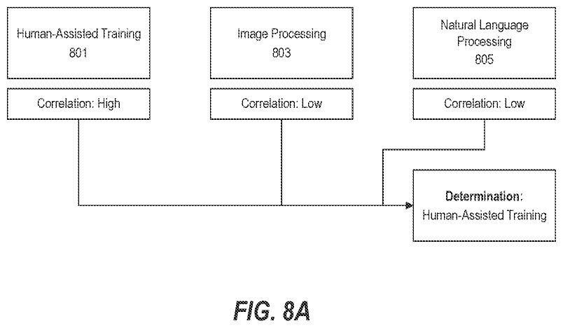

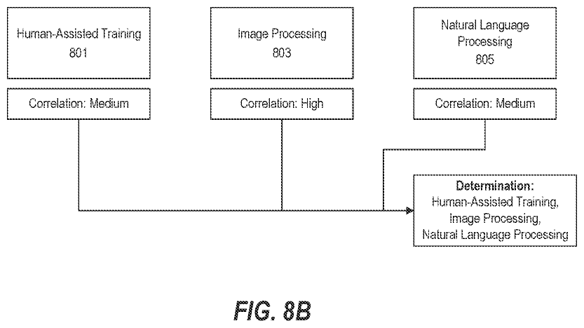

FIG. 3 illustrates a block diagram of a recommendation engine 303 for a persuasive statement determination, according to a disclosed embodiment. In some embodiments, the recommendation engine 303 is implemented as part of the processor 105 shown in FIG. 1. With reference to FIG. 3, the system 100 is operable to receive a determination 301 of a most relevant product via a multisystem model (such as a system illustrated in FIGS. 8A and 8B, as described below), for example using human-assisted training, image processing, and natural language processing. From this determination, the recommendation engine 303 is operable to correlate the determination 301, previous responses 305, and successful conversions 307 to a persuasive statement 315 most relevant to a determined goal (e.g., a high sales conversion goal). In some embodiments, the persuasive statement 315 is determined based on the correlation of the determination 301, previous responses 305, and successful conversions 307 with key sentences 317, prior correlation scores 319 from product reviews and descriptions, and/or any other product descriptions 321 received and/or stored by the recommendation engine 303. Previous responses may include, for example, responses generated by the recommendation engine 303 to a customer. Successful conversions may include, for example, conversations with a customer (providing customer inquiries) that led to a customer sale or other desired result. The recommendation engine 303 leverages these data points to create a more effective persuasive statement 315.

FIG. 3 further illustrates one example of persuasive statements for the classification of “sports” for a specific camera product and “wedding” for another camera product. Outputs 323 include multiple key sentences, for each of which the system 100 is operable to perform further correlations to the specific inputs of the user 101 and/or present one or more of the key sentences to the user 101.

In some embodiments, the recommendation engine 303 is operable to output multiple persuasive statements. In some embodiments, the system 100 is operable to combine the multiple persuasive statements into a single persuasive output that is communicated to the user 101 via the GUI. In another embodiment, the system 100 is operable to determine one or more persuasive statements that meet at least one preset criterion, and based on that preset criterion combine the persuasive statements that meet the criterion into a single output. For example, if the preset criterion includes a correlation value threshold of 0.70, the system 100 is operable to combine each of the persuasive statements greater than 0.70 and transmit the statements to the user 101 via the GUI. Alternatively, the system 100 is operable to provide the persuasive statement based on the correlation values, such as providing either the statement with the highest or second-highest correlation value. Each generated statement is given a correlation value that is determined based on a variety of factors such as information stored in the database 106 and/or inquiry data extracted from the customer inquiries.

The output may be presented to the user 101 on a specific portion of the GUI. The system 100 is operable to provide the content that is presented in the portion of the GUI. For example, the server 104 may provide content on one portion of the GUI, wherein the content may present a conversational tool with which the user 101 may provide inputs and converse with the system 100. This portion of the GUI may be called the conversational GUI. The conversational GUI may dynamically alter its positioning and location as the user 101 presents movements on the GUI. For example, if the GUI presents the ability for the user 101 to scroll up or down, the conversational GUI may dynamically move up or down as the user 101 engages in the scrolling function. Further, for example, the user 101 inputs or movements may be transmitted from the user device 102 to the server 104 (as these components are depicted in FIG. 1) over the internet 103, and the processor 105 of the server 104 may be programmed to analyze the user inputs or movements to dynamically alter the specific portion of the GUI that constitutes the conversational tool.

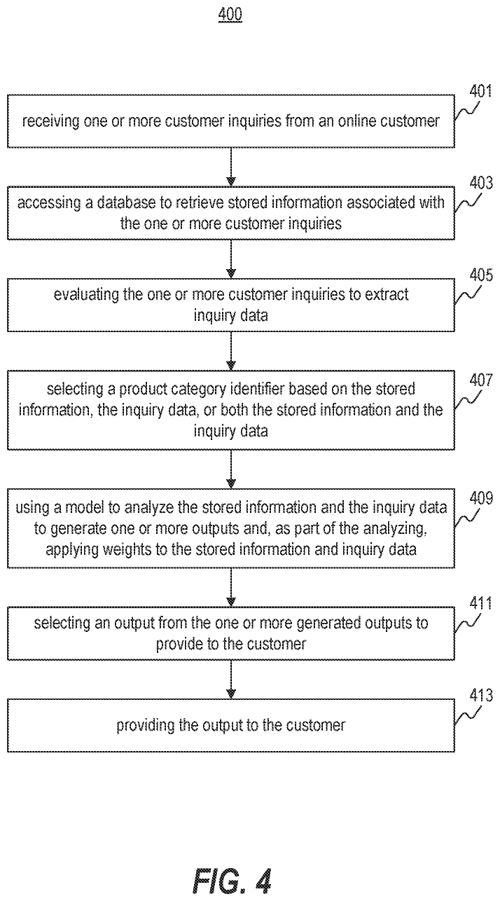

FIG. 4 illustrates a method 400 for generating and outputting an optimal response according to a disclosed embodiment. In the illustrated embodiments, the system 100 receives one or more customer inquiries from an online customer (401). The system 100 is operable to access a database to retrieve stored information associated with the one or more customer inquiries (403). The system 100 is then operable to evaluate the one or more customer inquiries to extract inquiry data (405). The system 100 is further operable to select a product category identifier based on the stored information, the inquiry data, or both the stored information and the inquiry data (407). The system 100 is then operable to use a model to analyze the stored information and the inquiry data to generate one or more outputs and, as part of its analysis, apply weights to the stored information and inquiry data (409). The system 100 is further operable to select an output from the one or more generated outputs to provide to the customer (411). Lastly, the system 100 is operable to provide the output to the customer (413).

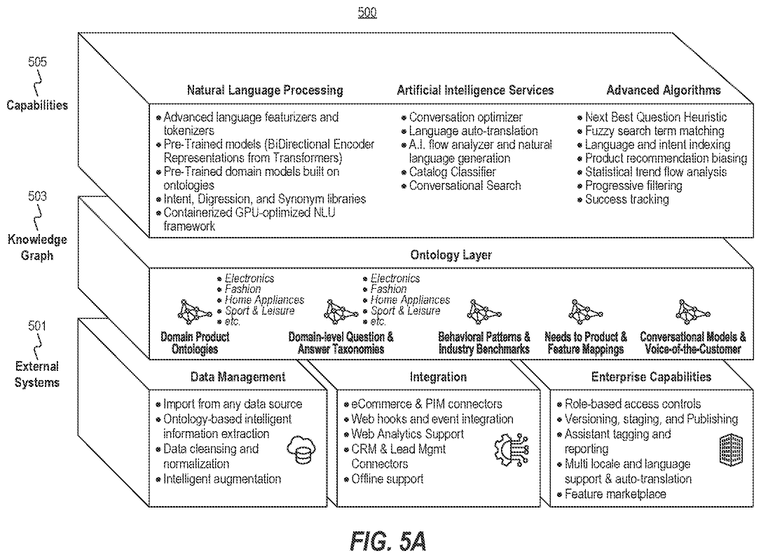

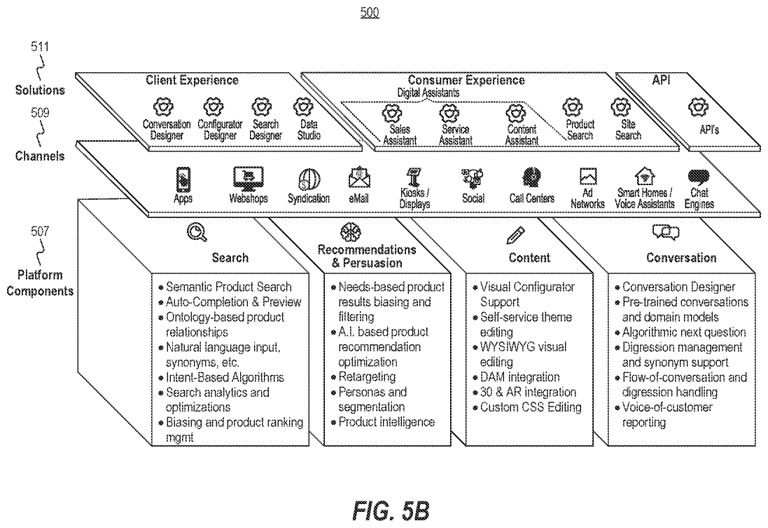

FIGS. 5A and 5B illustrate a system stack 500 of a persuasive recommendation system, according to disclosed embodiment. A first layer 501 of system stack 500 includes external systems for data management, integration, and enterprise capabilities; and a second layer 503 includes a knowledge graph ontology layer for determining otology and classification for products. The system 100 may use the external systems and knowledge graphs of the first and second layers in implementing the embodiments described. In some embodiments, a third layer 505 includes certain capabilities utilized by the system 100, including natural language processing (or machine learning) and artificial intelligence algorithms for correlating products and key sentences to inquiries, categories, and ontology. A fourth layer 507, in some embodiments, includes platform components, such as recommendation engines, content storage, and other tools for user interaction with the system 100. In some embodiments, a fifth layer 509 includes channels for interfacing with the system 100, and a sixth layer 511 includes solutions to be directly provided via the system 100, such as APIs, digital assistants, and other tools for facilitating connection between at least one outside user or system and at least one system disclosed herein.

In some embodiments, the system 100 is operable to weight and/or recommend products or responses with more recent relevant models and attributes based on historical behavior or historical information. In some embodiments, the information assessed by each of the learning models and/or received by the system 100 for generating a recommendation include: environmental factors, such as time, date, and location; parameters relating to the customer including customer behavior, customer demographics, and previous customer inquiries; parameters relating to other customers including behavior of the other customers, demographics of the other customers, previous inquiries from the other customers, and previous actions of the other customers; and stored product information including, but not limited to, inventory data and product trend data.

In some embodiments, the first layer 501 includes external systems that provide a variety of information. For example, a data management external system includes importation of unstructured data fed into the overall system that can be used during processing, wherein the data may be fed from a client source. Such data may include product descriptions, specifications, customer reviews, pricing, sales, and any other knowledge databases a client may have. After the data is imported, the system 100 may apply an ontology-based intelligent extraction process to organize and normalize the data. In some embodiments, the second layer 503 provides a knowledge graph of the imported data that organizes the information in a more manageable and usable format. For example, the knowledge graph can map out various products, product categories, common question-and-answer taxonomies, customer behavioral patterns, industry benchmarks, customer needs, product features, etc. Such mapping enables the system 100 to quickly and effectively generate responses or product recommendations when real-time customer inquiries are received.

In some embodiments, the third layer 505 applies a variety of models and processes to help facilitate the various embodiments described herein. For example, in some embodiments, the system 100 further includes natural language processing (NLP) engine configured to perform natural language classification. In some embodiments, the NLP engine is operable to analyze imported data from various sources, including unstructured information, and to receive unstructured inputs and generate classification categories based on the unstructured information. For example, in some embodiments, the data management external system may import unstructured information, e.g., a plurality of product reviews, from an external source. The NLP engine is operable to analyze and extract product attributes, such as keywords, sentiments, related concepts, related products, and characteristics. The system 100 is then operable to use the extracted attributes to both train a model and classify products. In developing a model, the system 100, in some embodiments, is operable to recognize, store, and/or attach attributes to a specific product. For example, if a particular product includes several negative reviews, the system 100 is operable to receive the reviews as text inputs and recognize repeated terms and/or terms semantically connected to a particular sentiment.

In some embodiments, the fourth layer 507 utilizes a variety of platform components 507 concepts to help facilitate the various embodiments described herein. In some embodiments, the system 100 is operable to utilize these platform concepts to practice disclosed embodiments. For example, in some embodiments, a user may be able to directly search for a product, and the system 100, in such embodiment, may conduct a product search and provide auto-completion of a user's intended search. The system 100 can leverage ontology-based product relationships or natural language processing to help facilitate these actions. As another example, the system 100 may utilize the Recommendations & Persuasion platform component and the conversation platform component to provide customers with recommendations or further questions during an online chat. In some embodiments, the fifth layer 509 depicts the various consumer-facing or client-facing channels that help facilitate the various embodiments described herein. For example, a consumer may begin a sales chat over a phone app or website to communicate with system 100. In some embodiments, there are two types of users that may communicate with the system 100 and facilitate the various embodiments described herein. For example, a consumer that is interested in a product purchase may use a phone app to communicate with online sales assistance for recommendations or other types of information. The online sales assistance may be in the form of a chat box as part of the graphical user interface presented by the phone app. Further, system 100 is operable to provide the online sales assistance with responses and recommendations, as described in various embodiments herein. In some embodiments, the user may be a client interested in selling products to consumers. For example, this client may use a web platform to open a conversational designer that will allow the client to communicate with system 100 and change certain features of the chat box that a consumer may see, such as (but not limited to) the design of the chat box.

### II. Deep Learning Algorithms

In normal human conversations, especially those in a sales setting, the parties usually interact through a sequence of questions and answers. Each answer usually influences the next question. For example, if a salesperson asks, “Are you looking for a bike for an adult or a child,” and the customer answers with, “Child,” then the next question may be, “How old is the child?” In conversations with both in-person, virtual, and bot-based interactions, however, a salesperson or a bot may not be able to determine exactly which question will best meet the customer's needs and/or result in a sale. For example, there may be multiple questions that could narrow a product suggestion, such as, “What color bike would you prefer?” or “Do you want a bike for road cycling or trail riding?” In this case, the salesperson or bot must decide which question is best to ask.

Some embodiments are operable to provide a method of determining which question or response to suggest that will increase the likelihood of achieving a set objective (e.g., a sales conversion and/or a suggestion of products that will achieve a revenue goal). In some embodiments, this question-and-answer process occurs through a hierarchy of decisions that start with a “hard” filter that automatically isolates any questions that would not be appropriate or would not yield a good output, based on the customer interaction, the determined customer needs, and/or product information (i.e., a product inventory or classification information stored with the product). For example, if the system 100 determines that there are two candidate questions or responses for a customer, the system 100 is operable to predict that one question is more relevant to the customer's inquiry and/or that the question would increase the likelihood of an intended result occurring, such as a sales conversion.

The system 100 is operable to, in some embodiments, make a determination of which question or response to provide to the user 101 based on optimizing at least three factors, including: timing, scalability, and flexibility. First, with regard to timing, traditional prediction models may be slow. In order to structure conversations that result in natural, effective, and persuasive conversations, the system 100 is operable to respond within a short period of time. In some embodiments, the response time is less than one decisecond. In some embodiments, the response time is less than 200 milliseconds. In some embodiments, the response time is less than half a second. In some embodiments, the response time is less than one second. Second, scalability is an issue with many different recommendation systems as well as hierarchical question-based systems. Because storing, accessing, and analyzing the many different combinations of questions and responses requires significant storage and computing power, the question-and-answer process should not sacrifice speed and flexibility for scalability. Lastly, with regard to flexibility, there are many products that are affected by externalities that relate to prediction, availability, and relevancy (e.g., fashion trends, general trends, product catalogue changes, historically successful products that are not available, new products that will be highly successful, and answer propensity, such as the effect of major holidays on the relevancy and desire for a product). These factors are likely to change quickly, and the system 100 is operable to respond to these changes quickly to maintain relevancy.

In some embodiments, the system 100 recommends products based on a combination of three Deep Reinforcement Learning algorithms: (1) Deep Q Networks (DQN family), policy gradients (e.g., REINFORCE), and actor-critic methods (e.g., A2C and/or A3C).

Q-learning approaches using a tabular method have been used to make recommendations. Generally, the system 100 is operable to determine the best question to present to the user by Reinforcement Learning. For example, the system 100 is operable to use a tabular Q-Learning algorithm, where for every state S (i.e., answer vector) and action A (i.e., next question asked), the system 100 is operable to store an estimated Q-Value and take the action A that has the highest estimated Q-Value. This approach optimizes the actions taken by system 100. A problem with this optimization approach, however, is that computation and storage limits reduce its efficacy. Generally, in conventional systems, there are problems with the system's inability to handle continuous features, as opposed to discrete features, and it may not be possible to extrapolate knowledge from a (state, action) pair that the conventional system has never seen before. Additionally, estimating the Q-value for each unique (state, action) tuple usually requires sampling each tuple several times to derive a confident estimate of a Q-value, and this may be difficult with a low number of user sessions to sample. Further, the more complicated an assistant is, the more (state, action) pairs there are stored. In order to effectively store and process each of these pairs, the system 100 is operable to reduce the number of combinations used, such as only using the last three questions answered, limiting the number of questions presented, discretizing slider values, etc. This targeted approach utilized by system 100 directly addresses the scalability concerns of conventional systems. The embodiments disclosed herein include such functionalities to overcome the above problems.

Uniquely, the system 100 includes, in some embodiments, an algorithm that replaces a measurement of an expected click-out rate Q for each (state, action) pair with a function ƒ(S,A)→Q that estimates clickout rates from answer vectors. In some embodiments, the system 100 employs supervised algorithms such as Support Vector Machines (SVMs) or RandomForests to estimate this function. Many prior art methods will not work to estimate these rates because of two problems: (1) supervised learning generally expects data to be Independent and Identically Distributed (IID) random variables; and (2) reinforcement learning data is often non-stationary, where—unlike supervised problems—the “target variables” change over time. This second problem may occur with tree- or kernel-based methods. In some embodiments, the system 100 employs the conventional stochastic gradient assent/descent method, which is not particularly affected by this issue.

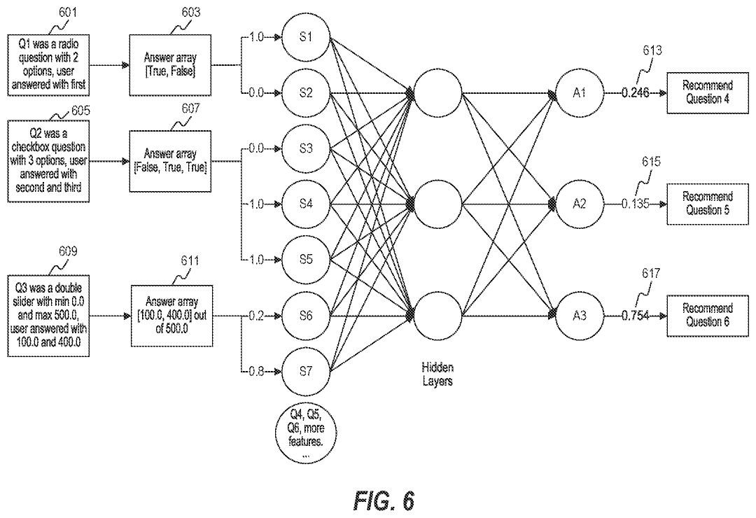

FIG. 6 illustrates a prediction model using a Deep Q Network (DQN) approach to persuasive recommendation according to a disclosed embodiment. In the illustrated embodiment, the system 100 receives inputs to three different questions. Alternatively, the inputs may be based on stored information in the database 106 depicted in FIG. 1 and/or inquiry data extracted from one or more customer inquiries. A first input 603 is a response to a question Q1 601 with two radio options; a second input 607 is a response to a question Q2 605 with three checkbox options; and a third input 611 is a response to a question Q3 609 with a slider between 0.0 and 500.0. These inputs are communicated to the system 100 with certain assigned values. For example, a user responds to question Q1 601 by selecting a first of two options, thus assigning the value 1.0 to the first option and 0.0 to the second option. This input is communicated to the system 100 and represented by S1. Similarly, S2-27 represent the other responses communicated to the system 100. Based on these inputs, the system is operable to determine a recommended next best question. For example, in the illustrated embodiment, Action A1, which would recommend Question 4 as a response, has a correlation value of 0.246 (613). Action A2, which would recommend Question 5 as a response, has a correlation value of 0.135 (615). Action A3, which would recommend Question 6 as a response, has a correlation value of 0.754 (617). In some embodiments, a loss function is calculated by determining the difference between the network's Q and the observed Q (clickout rate). The system 100 is operable to manually or automatically adjust the weights and biases for each factor, question, answer or other input or output to minimize the loss function. In some embodiments, the system 100 is operable to use one or more of the following systems to circumvent Independent and Identically Distributed (IID) and non-stationarity concerns that tend to normalize or standardize results: Prioritized Experience replay buffer, N-Step Learning, Double Deep Q Networks (DDQN), Dueling Q-Networks, and/or Noisy Networks.

In some embodiments, the system 100 uses Deep Q Networks to recommend products. Some embodiments of Deep Q networks were originally developed by Google and published in Nature in 2015, “Human-Level Control Through Deep Reinforcement Learning,” by Mnih, et al., published Feb. 26, 2015, which is hereby incorporated by reference in its entirety. However, in some embodiments, the system 100 uses modified versions of the Deep Q Networks to provide more effective product recommendations, including implementing features in the Deep Q Networks such as, but not limited to, Prioritized Experience Replay, Double Deep Q Networks (DDQN), Dueling Q-Networks, and Noisy Network layers. In other embodiments, the system uses Deep Q Networks with layers having different architecture to accommodate different inputs. For example, in some embodiments, the Deep Q Networks use image inputs, while, in other embodiments, the Deep Q Networks use non-image based inputs, which can include words, statuses, or the like.

In some embodiments, the system 100 utilizes reinforcement learning (RL) algorithms, such as “gym,” including a hidden layer portion including hidden layers of 64 neurons+a Rectified Linear Unit (ReLU) activation function+an Adam optimizer with a low learning rate parameter (e.g., a variable set to a value of approximately 0.00025). In some embodiments, the number of neurons is adjustable. For example, as part of the processing occurring at the hidden layer portion, the system 100 conducts exploration analysis to determine every possible outcome path. This may include analyzing the information received as inputs S1-S7 to understand what question (or response) would be optimal. For example, based on the analysis done at the hidden layer portion, system 100 may determine specific confidence values for each action A1, A2, and A3, and select the action with the largest value.

In some embodiments, the hidden layers represent various models that are used by system 100, including one or more of the following: Prioritized Experience replay buffer, Double DQN (DDQN) & Dueling Q-Networks, and Noisy Layers. For example, at each neuron in the hidden layer, one or more of these models may be applied. In some embodiments, the hidden layers consist of one or more layers such that an input to the hidden layers flows through each of the one or more layers. In other embodiments, an input is received at the hidden layers, which may be an image-based or non-image based state, and sent to a ReLU activation function. In some embodiments, the output from the ReLU activation function is sent to the Noisy layers. In other embodiments, the output from the Noisy layer is sent to the Double DQN (DDQN) & Dueling Q-Networks layer to calculate the Q-value.

In some embodiments, the system 100 further includes a target network, wherein the target network is a copy of the original DQ network that is used to generate predictions before any episodes have occurred (i.e., K=0). An episode can be an update to the original DQ network based on a determined response or a recommendation to a customer inquiry. The target network provides the target Q values the original DQ network should aim to reach. Over time, the system 100 trains the original DQ network to perform better, based on the target network and the target Q values. In some embodiments, for every K episodes, the system 100 is operable to replace the target network with a new copy of the original DQ network. This improves the estimation of the expected click out rate Q, because after every training, the target Q values naturally change and, therefore, system 100 needs to be retrained. Updating the target network every K episodes helps to control instability. This upgrading is also beneficial, since a conversation optimizer can be trained twice per day instead of after every episode, thus enabling the system 100 to quickly return predictions and responses faster than conventional systems without constant training. The system 100 is further operable to train the original network and replace the copies. In some embodiments, this occurs approximately two or three times in a 24 hour period.

In some embodiments, the system 100 further employs a Double DQN model to calculate loss, such as the process described in “Deep Reinforcement Learning with Double Q-Learning,” by van Hasselt, et al., published Dec. 8, 2015, which is hereby incorporated by reference in its entirety. In some embodiments, the use of the Double DQN model reduces the overestimation of expected Q values. In one embodiment, the calculated loss is the mean squared error of observed Q and expected Q, wherein using a DQN, the expected Q is the neuron that has a maximum output:

reward+gamma*dqn+target(next_state).max(dim=1,keepdim=True).

This provides the target network's value of the next state. The Double DQN (DDQN) & Dueling Q-Networks provides:

selected_action=dqn(next_state).argmax(dim=1,keepdim=True)

target=reward+gamma dqn_traget(next_state).gather(1,selected_action)

This provides the “original” network's best action's values according to the target network.

In some embodiments, the estimates for the expected click out rate Q not only provide the value of a (state, action) pair but also split them into a value of (state) plus an advantage of choosing (action) at a given state. In some embodiments, the system uses the Dueling DQN to perform this function. For example, in some embodiments, the Dueling DQN uses Noisy layers as its network architecture. In other embodiments, the Dueling DQN uses linear layers. The system accomplishes this by modifying a neural network.

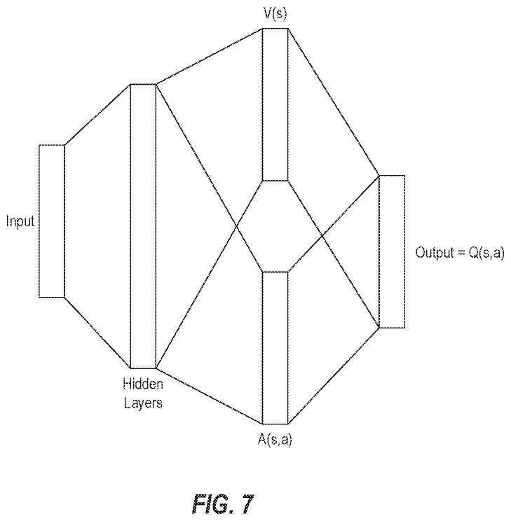

FIG. 7 illustrates a prediction model using a Dueling DQN approach to persuasive recommendation, according to a disclosed embodiment. In some embodiments, instead of computing Q(state, action) as in the DQN in FIG. 6, the system 100 splits the second-to-last layer into two: value V(s) and advantage A(s,a) function. In some embodiments, the system 100 uses an open-source machine learning framework, such as PyTorch, to accomplish this. FIG. 7 depicts a network with Q(s,a)=V(s)+A(s, a). Because V and A cannot be specifically identified from Q, the system 100 is operable to subtract the average advantage A of all state-action pairs s and a, which increases the stability of the optimization.

In some embodiments, the system 100 employs Noisy Networks to obviate an exploration versus exploitation dilemma. In some embodiments, the system 100, when employing Noisy Networks, introduces noise in the weights and biases of a network, to ensure that the network will explore more efficiently. Because noise is built into the second-to-last layer, the network will adapt over the course of the learning process. In some embodiments, this is used instead of an epsilon-greedy approach. In some embodiments, the noise is introduced using a method similar to that described in “Noisy Networks for Exploration,” by Fortunato, et al., published Jul. 9, 2019, which is hereby incorporated by reference in its entirety. However, in some embodiments, this method could introduce noise to the weights and biases such that, over time, the weights and biases converge to zero and reduce the amount of exploration the system engages in. While this may be workable for a network that is in a non-changing environment such that a system can reach an optimal performance level and not require further exploration, this approach would not be effective for networks in changing environments that, for example, use real-time data such as customer inputs or new product information. In some embodiments, the system 100 introduces noise to the weights and biases with the result that the system conducts sufficient exploration to reach optimal performance levels. In some embodiments, the system 100 uses higher weights and biases. In other embodiments, the system 100 determines the weights and biases to use based on an expected rate of change of the environment the system 100 is operating in. In some embodiments, system 100 monitors the weights and biases in real-time and adjusts them according to changes in the environment and/or the impact of adding noise to the weights and biases. In other embodiments, this monitoring and adjustment can provide a more effective exploration process for system 100.

In some embodiments, the system 100 uses a Categorical DQN to increase the performance of the network and decrease risk of system instability. In some embodiments, instead of just getting the output neuron with the highest Q-value, the system 100 is operable to add a softmax function layer, sample neurons randomly, and use the output of the softmax function as a probability distribution of Q-values. In some embodiments, the system 100 applies the Categorical DQN function as disclosed in “A Distributional Perspective on Reinforcement Learning,” by Bellemare, et al., published Jul. 21, 2017, which is hereby incorporated by reference in its entirety. In other embodiments, the system 100 applies the Categorical DQN function to the Dueling DQN approach by categorically approximating the advantage A(s,a) function that is used in the Dueling DQN approach.

In some embodiments, the system advantageously avoids “Catastrophic Forgetting.” Catastrophic Forgetting is a state that a neural network trained for a specific task based on certain data completely forgets when attempting to learn new tasks based on new data. This happens in some situations due to the network being trained with new user behavior and/or environment changes causing the network to forget how to recommend states prior to the new training. Catastrophic Forgetting also happens if the neural network is trained for multiple tasks, but forgets a task it learned earlier once it is trained for another one.

The system 100 advantageously overcomes these Catastrophic Forgetting situations by employing an Experience Replay Buffer, Clipping Gradients, and/or Elastic Weight Consolidation (EWC). In employing the Experience Replay Buffer, the system 100 is operable to buffer old states as well as new states and use these states to retrain—which therefore adjusts the weights based on previously seen experiences. This allows for hyper-tuning to different buffer sizes and other parameters. With Clipping Gradients, the system 100 is operable to scale all gradients in a range of −1 to 1, in order to prevent some gradients from becoming too high. This way, the network makes sure that the weights for previously seen states do not become extremely low and the weights for recent states do not become extremely high. With EWC, the system 100 is operable to update the network weights so that the model does not forget past learnings and enables continual learning. In other embodiments, the system 100 may employ the Prioritized Experience Replay Buffer with which system 100 is operable to randomly buffer old states, as done when employing the Experience Replay Buffer, but additionally apply a sampling approach that prioritizes newer samples when buffering older states, thus addressing the flexibility and relevancy issues that plague conventional systems that are negatively impacted by changing environments and trends. This ensures that buffering of old states that occurred a significant period of time before (and, thus, could be less relevant) are not impacting system 100 as much as old states that did not occur as long ago. In other embodiments, employing the Prioritized Experience Replay Buffer also allows system 100 to apply weights to old states such that they are buffered more or less often depending on the weight given. In some embodiments, the Prioritized Experience Replay Buffer is not created until the initial Q-values are generated. In other embodiments, the Experience Replay Buffer or the Prioritized Experience Replay Buffer keep track of the Q-values and recommended actions. In some embodiments, the system 100 is operable to implement a process similar to that described in “Overcoming Catastrophic Forgetting in Neural Networks,” by Kirkpatrick, et al., published 25 Jan. 2017, which is hereby incorporated by reference in its entirety.

### III. Training

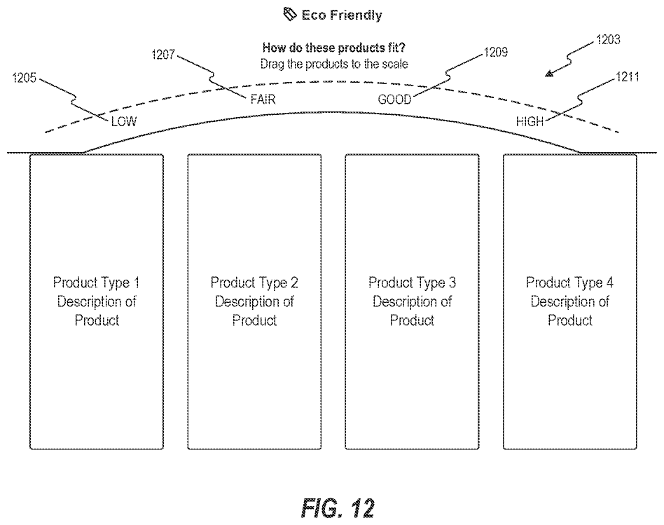

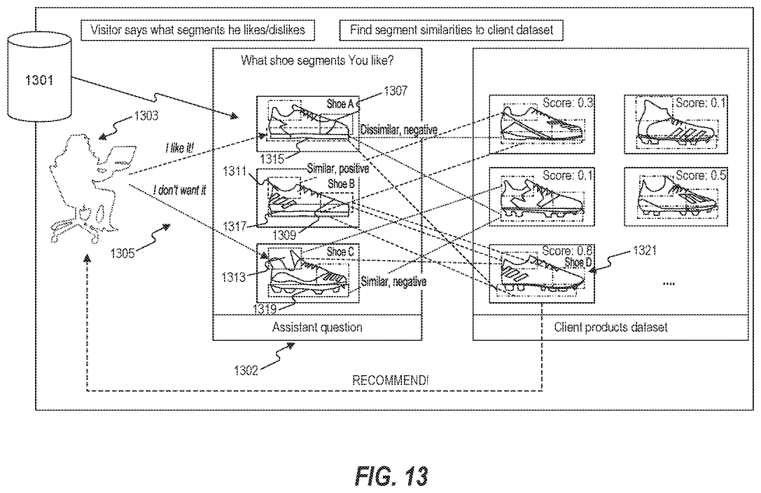

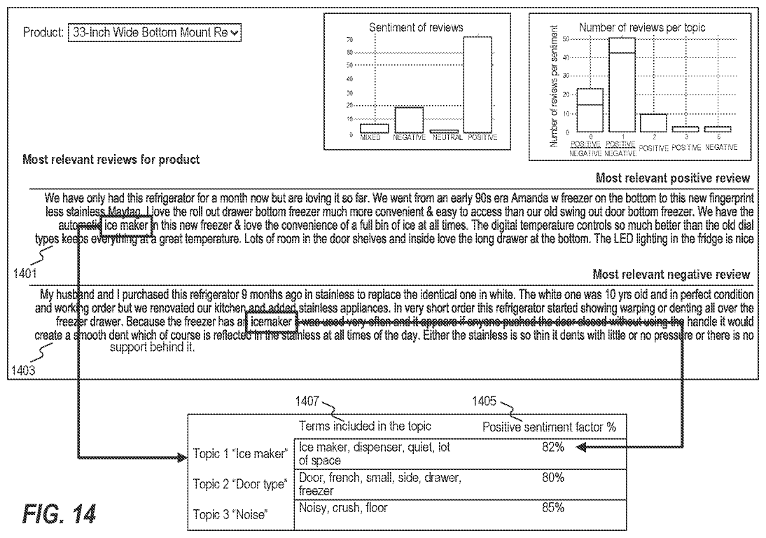

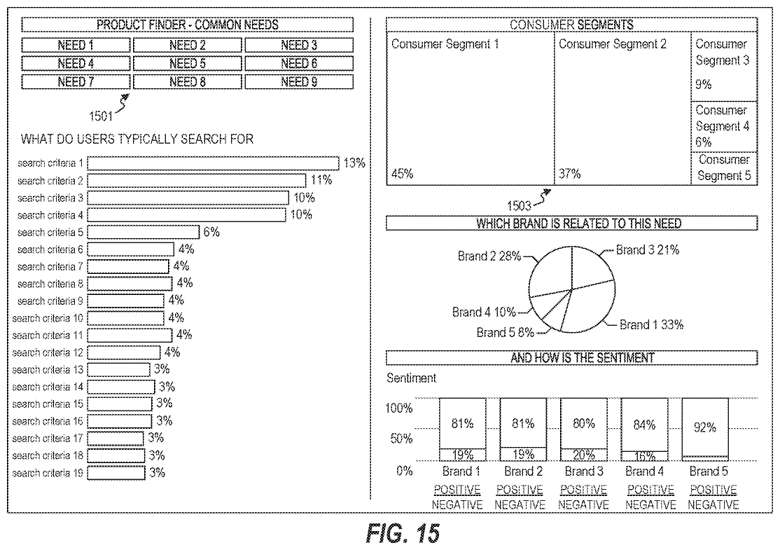

In some embodiments, the systems herein develop and employ a variety of machine learning models in combination. Notably, the disclosed embodiments combine multiple prediction algorithms and/or engines across a variety of input and output kinds (i.e., text, speech, images, human-aided training) to produce recommendations or responses that are more natural and/or persuasive than a single prediction engine. FIG. 8A illustrates a recommendation engine with a determined best single classification engine from three classification engines according to an embodiment. More particularly, FIG. 8A illustrates a combination of a Human-Assisted Training (HAT) engine 801 (such as those illustrated and described below with respect to FIG. 12), an image processing engine 803 (such as those illustrated and described below with respect to FIG. 13), and a natural language processing engine 805 (such as those illustrated and described below with respect to FIGS. 14-15). When multiple predictive models are used, it can be difficult to determine which model or combination of models is best to use. In some embodiments, the system 100 is operable to overcome that problem by performing a unifying prediction analysis. For example, in some embodiments, the system 100 determines a relevancy score or a correlation score for each prediction engine to determine whether a unified, multiple, or single-engine prediction would provide the most accurate recommendation for a predetermined outcome. This determination improves selection of a recommended product or response because sometimes a certain product category identifier is strongly associated with a certain medium of relevancy, such as a customer inquiry that relates mostly to a visual characteristic or a specific descriptive term.

FIG. 8A illustrates a unifying prediction analysis, wherein the system 100 makes single-engine determination. In the illustrated embodiment, the HAT engine 801 outputs a high correlation value between a specific product and a customer inquiry, while the image processing engine 803 and the natural language processing engine 805 each output low correlation values. Because the system 100 determines that the three engines 801-805 are not highly reinforcing and there is strong disagreement between the HAT engine 801 and the other engines, the system 100 is operable to make a recommendation based on the HAT model alone.

Alternatively, FIG. 8B illustrates a recommendation engine with a determined best combination classification engine from three classification engines, according to a disclosed embodiment. In some embodiments, a unifying prediction analysis is utilized, wherein a system makes a multiengine determination. In the illustrated embodiment, the HAT engine 801 outputs medium correlation values, the image processing engine 803 outputs high correlation values, and the natural language processing engine 805 outputs medium correlation values. Based on the correlation values and a determination that the models are reinforcing, the system 100 is operable to determine that a blended prediction has the greatest chance of producing a predetermined outcome. Notably, the system 100 is operable to determine that any combination of engines is reinforcing for a particular product inquiry. For example, in some embodiments, a natural language processing engine with a high correlation value is unified with an image processing engine with a medium correlation value, but the system 100 ignores the human-assisted training engine recommendation due to a correspondingly low correlation value.

In some embodiments, the predetermined outcome the system 100 is configured to optimize or establish the greatest chance of producing a successful outcome is based on past activity. For example, in some embodiments, the predetermined outcome of the system 100 is a percent chance that a user will purchase a product. In some embodiments, the system 100 receives a manual input threshold for recommending a product, where a product with a determined prediction greater than a certain likelihood of purchasing (i.e., correlation percentage) is then recommended to a consumer. In another embodiment, the system 100 determines a product from a database with a maximum present likelihood (i.e., correlation percentage) related to a customer inquiry and recommends that product to the customer.

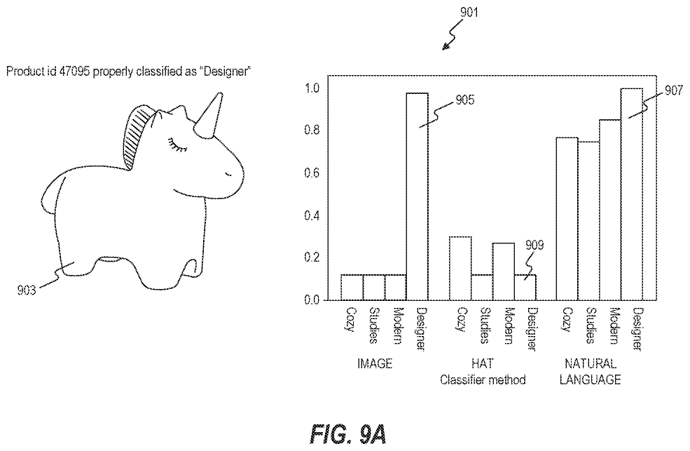

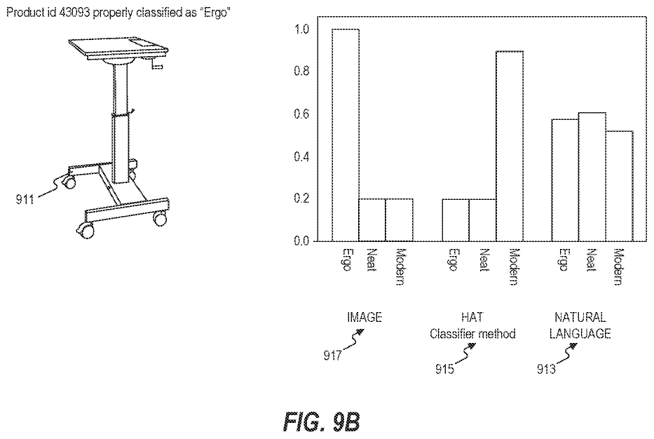

FIG. 9A illustrates a visual classification recommendation, according to a disclosed embodiment. More particularly, FIG. 9A shows a graphical depiction of a unification system for a designer product. In some embodiments, the system 100 is operable to determine that, even with a high correlation value, a single- or multiengine predication value is the most optimized toward the predetermined outcome. For example, with reference to FIG. 9A, a graph 901 visually indicates correlation of four different words (i.e., cozy, studies, modern, designer) via three different classifier methods and classifier engines (e.g., image processing, human-assisted training, and natural language). A product 903 is a designer unicorn-themed lamp, wherein the product is highly correlated to the word “designer” by a visual engine 905 and a natural language engine 907 but not by a human-aided classification engine 909. While the natural language engine is closely aligned with the inquiry of “designer,” the system 100 is operable to calculate a confidence score for each of the prediction engines. In the illustrated embodiment, the confidence score is low for the natural language engine due to the presence of many other keywords and other relevant categories pulled from textual descriptions associated with the product (“cozy,” “studies,” “modern”). The visual correlation score, however, is very high for the term “designer,” but it is correspondingly low for the terms “cozy,” “studies,” and “modern.” Thus, the confidence score for the system 100 is higher for the visual aspect, and the system is operable to determine the visual engine and the natural language engine are reinforcing and determine a higher correlation score for the product as a whole before making a recommendation. In some embodiments, the system 100 is further operable to classify the product as “designer” based on the single- or multiengine system herein.

The approach illustrated in FIG. 9A is beneficial because a product such as the unicorn-themed lamp may have little to no indication that the product is unique or unusual based on analysis in a single-engine (e.g., the natural language engine 907 output here). When the engines are unified, however, a classification for some products becomes more apparent.

FIG. 9B illustrates a visual classification recommendation, according to another disclosed embodiment. More particularly, FIG. 9B illustrates a graphical depiction of the unification system for an ergonomic product. In the illustrated embodiment, a product 911 is a desk, wherein a natural language engine 913 has a low confidence interval for any of the terms “ergo,” “neat,” and “modern,” but has a medium correlation value for all three terms together. In contrast, a visual engine 917 has a high confidence in the correlation value for “ergo.” A human-aided classification engine 915 has a high correlation for “modern” but a medium confidence interval. In some embodiments, the system 100 is configured to select a classification or recommend a product based on the highest confidence interval, which, in the illustrated embodiment, is the “ergo” classification. In some embodiments, the system 100 is configured to select a classification based on a combination of both correlation value and confidence interval, which, in the illustrated embodiment, would also be “ergo.” In some embodiments, the system 100 is configured to base its classification on a combination of the categories with the highest correlation values. In some embodiments, the system 100 is operable to assign at least two classifications to a product based on a combination or weighting of multiple prediction engines.

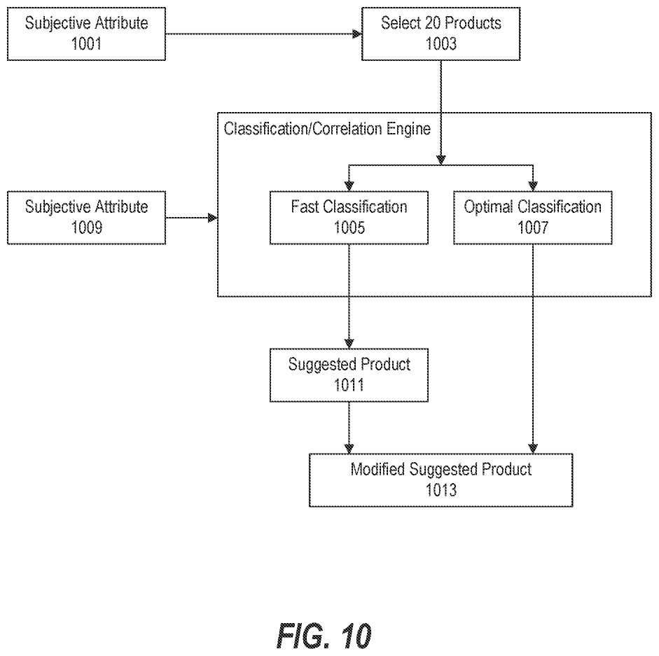

FIG. 10 illustrates Fast Classification and Optimal Classification training and recommendation, according to a disclosed embodiment. More particularly, FIG. 10 is a flowchart illustrating a product classification and training algorithm for human-assisted training, according to some embodiments of the present embodiment. In the illustrated embodiment, the system 100 receives a subjective attribute 1001 for product classification. The system 100 is then operable to select 1003 a set of products for classification. For example and without limitation, the number of products in the present example is 20 products. In some embodiments, the selected number of products is a manually input number per classification. In some embodiments, the selected number of products is a percentage of the total number of products in a database or catalog. Because optimal and complex classification can take significantly longer than a user is willing to wait during a classification training session, the system 100 is operable to perform a dual-classification process, wherein a fast classification 1005 occurs simultaneously with an optimal classification 1007.

In the embodiment illustrated in FIG. 10, the fast classification 1005 receives an indication of the selected set of products 1003 and a subjective attribute 1009, and based on the subjective attribute 1009 performs a fast classification for the selection of products 1003. In some embodiments, the system 100 uses fast regression techniques that are time bounded. In some embodiments, the fast classification occurs in “real-time,” which occurs in less than 2 seconds. In other embodiments, the fast classification occurs in less than 10 seconds. In further embodiments, the fast classification occurs in less than 30 seconds. In yet another embodiment, the fast classification occurs in less than 60 seconds. The system 100 is operable to employ any regression technique capable of performing fast classification, including lasso, Decision Tree, or Stochastic Gradient Descent. In the illustrated embodiment, the system 100 outputs a suggested product 1011, wherein the suggested product is one of the selected products 1003 that is recommended by the recommendation processes illustrated in FIGS. 1-6.

In the embodiment illustrated in FIG. 10, the classification/correlation engine performs an optimal classification 1007 simultaneously, in succession, and/or at some time after the fast classification 1005 begins or ends. This dual-process classification allows for a user to get preliminary rough suggestions and not have to wait for the most accurate suggestions. Sometimes, the optimal classification 1007 will take longer than a user is willing to wait. Thus, the dual classification allows for quick results that are less accurate for a given goal or desired outcome, and then an updated, more accurate prediction is provided later. The optimal classification 1007 includes relevant methods, procedures, and algorithms that require longer times to recommend but are more accurate for a predefined goal or predicted outcome. In some embodiments, a list of suggested products and attributes associated with a list of suggested products (i.e., a correlation score and/or a confidence interval) are provided to the optimal classification process 1007, wherein the optimal classification 1007 determines a modified suggested product based on the list of suggested products and attributes associated with the list of suggested products. In some embodiments, the optimal classification 1007 performs independently of the fast classification 1005, and an output from the optimal classification 1007 (i.e., a modified suggested product 1013) replaces the suggested product from the fast classification 1005.

In some embodiments, the system 100 is operable to store multiple classification categories and attributes for a particular product. The system 100 is operable to retrieve stored classifications and attributes for a product from a memory and, based on the stored classifications and attributes, generate questions, responses, and other communicative outputs to provide relevant products for a specific goal or desired outcome. For example, if the system 100 receives a customer inquiry corresponding to a bicycle, the system 100 is operable to retrieve relevant attributes and subcomponents (i.e., an ontology) connected to the classification of “bicycle.”

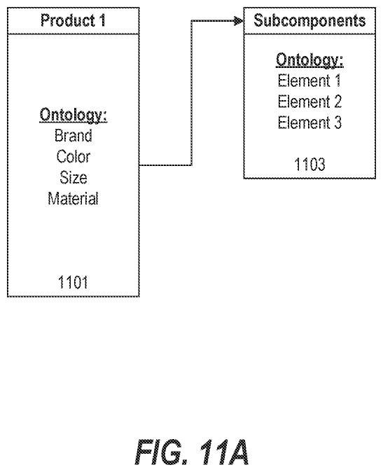

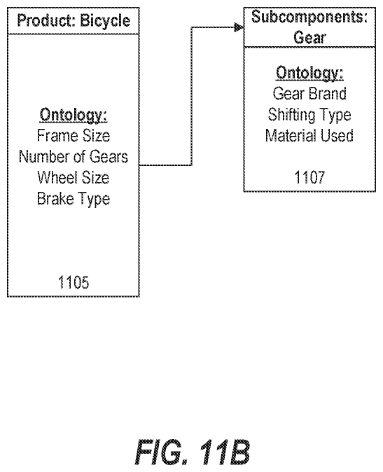

FIG. 11A illustrates a generic product ontology with subcomponents according to an embodiment. More particularly, FIG. 11A illustrates one example of classifications and ontology for a generic customer inquiry. In the illustrated embodiment, the ontology includes Brand, Color, Size, and Material. Notably, the product is operable to be paired, stored, or connected with any ontology category that is manually or automatically determined to be relevant to the product. In the illustrated embodiment, if the system receives a consumer inquiry related to Product 1, the system 100 is operable to retrieve and utilize the ontology connected to Product 1 and utilize the ontology to generate and serve a response or prompt to a user regarding a Brand, Color, Size or Material of the suggested product. In some embodiments, the system 100 is further operable to generate, store, and retrieve attributes and/or categories for subcomponents of a stored product. For example, in the illustrated embodiment, Product 1 has categories for associated subcomponents, wherein the information is stored hierarchically for each subcomponent. In some embodiments, the subcomponents include further corresponding subcomponents, wherein the memory is operable to store any number of additional subcomponent levels.

FIG. 11B illustrates a bicycle product ontology with subcomponents, according to a disclosed embodiment. More particularly, FIG. 11B illustrates one embodiment of a product attribute and classification stored in a memory of the system. In the illustrated embodiment, the product is a Bicycle, wherein the bicycle includes multiple classifications, including a Frame Size, a Number of Gears, a Wheel Size, and a Brake Type. In an exemplary embodiment, the system 100 is operable to receive a customer inquiry regarding a bicycle, and based on a determined relevant classification, the system 100 is operable to search, query, prompt, and/or present information based on the ontology associated with the classification of Bicycle. If, for example, a customer inquiry relates to a child's bicycle, the system 100 is operable to query and determine a Frame Size and one or more products relevant to the customer inquiry. In a further embodiment, the classification may be stored with subcomponents, including a Gear Brand, a Shifting Type, a Material Used, and/or other ontology that are relevant to a specific classification and/or customer inquiry.

As explained above, one model utilized by the system 100 includes a Human-Assisted Training model, wherein the system 100 receives an input from a user that classifies a specific product on a subjective scale. For example, in one embodiment, the system 100 receives an input from a user ranking one or more products in comparison with at least one product for a specific classification. For example, the system 100 may prompt and receive a classification for products “good for travel,” “good for gifting,” or “impress your friends.” The system 100 is then operable to provide a set or subset of products for a human to manually classify. In some embodiments, the training includes a graphical representation of the products and a graphical ranking mechanism. In some embodiments, the system 100 is operable to receive numerical inputs, wherein the numerical inputs are discrete and/or continuous. In some embodiments, the system 100 prompts and is operable to receive a ranking based on a nonnumerical scale, such as “low,” “medium,” “high,” or “bad,” “neutral,” “good,” “better.”

FIG. 12 illustrates a human-assisted training graphical user interface (GUI), according to a disclosed embodiment. More particularly, FIG. 12 illustrates a graphical training mechanism. In the illustrated embodiment, a product is presented to the user 101 via a graphical user interface (GUI) on the user device 102. In some embodiments, the GUI includes a graphical categorization mechanism, wherein the GUI is operable to receive inputs from the user 101 that classify a product according to a desired attribute. For example, in FIG. 12, the product displayed on the GUI is different types of the same product (e.g., an oven), and the classification attribute is “Eco-Friendly.” In the illustrated embodiment, the GUI includes a slider 1203 with a scale of values. The scale in some embodiments is discrete with positions at “Low” 1205, “Fair” 1207, “Good” 1209, or “High” 1211. If the user 101 slides the product to a “Low” position 105, the GUI is operable to receive that input and transmit or store the value in connection with the product. In some embodiments, the scale is continuous, wherein a position on the slider corresponds to a number or value. For example, in some embodiments, a position on the highest end of the scale corresponds to a value of 1.0, a position on the lowest end of the scale corresponds to a value of 0.0, and a position in the middle of the scale corresponds to 0.5. In some embodiments, the GUI is operable to receive a click-and-drag input from the user 101 to assign a value to the product. In some embodiments, the input is a click, press, tap, slide, swipe, or manually entered numerical value.

The GUI is further operable to transmit the inputs to the processor 105, wherein the processor 105 is operable to receive and store the inputs. In some embodiments, the inputs are stored with a product profile, wherein the product profile includes characteristics about the product, including ontological descriptors, user-input classifications, correlations to other products, correlations to successful conversions, and/or correlations to specific consumers or group of consumers.

In some embodiments, the relevant attribute is established by the user 101. For example, the GUI is operable to prompt and/or receive an input related to a desired attribute. If a user inputs the attribute “Good for Gifting” or “Impress Your Friends,” the GUI is operable to receive and transmit inputs from the user 101 to the processor 105 via the systems and methods described herein. In some embodiments, once the GUI receives the desired attribute, the processor 105 is operable to query and/or retrieve a selection of products and display those products to the user 101. In some embodiments, the selection of products is varied in terms of values for objective attributes. For example, if the desired attribute is “Eco-Friendly,” the processor 105, in some embodiments, returns a selection of twenty products, where each of the products has various characteristics corresponding to its objective attributes (e.g., gas ovens, electric ovens, convection ovens, single range, double range, freestanding, slide-in, etc.). In some embodiments, the system 100 is operable to determine a selection of products that are most dissimilar to each other. In some embodiments, this means that there are no two products in the selection that are the same, or there are no two products in the selection that have the same predetermined characteristic. This dissimilarity aids the training model, because with greater the dissimilarities between the selected products, the more the system 100 is operable to determine how well user-based training values apply to various attributes.

In some embodiments, the system 100 further employs a visual-based training model, including an image classification model. In some embodiments, the image classification engine analyzes each image associated with one or more product images in a catalog to build a neural network identifying similarities and differences between the images. Based on labeled differences between products via ontology and a knowledge graph, the system 100 is operable to effectively identify common differences and how the visual elements relate to textual descriptions and other product classifications and attributes. In some embodiments, the visual classification engine receives the human-assisted training values, finds correlations between common image features or combinations of images features, and then determines a score for the subjective attribute.

FIG. 13 illustrates a diagram of a visual training engine, according to a disclosed embodiment. More particularly, FIG. 13 illustrates a visual-based model training procedure. Illustrated is one embodiment of a procedure and/or algorithm that the system 100 is operable to perform to classify various products according to subjective attributes provided by a user. In the illustrated embodiment, the system 100 is operable to load product images from a database (1301), provide a selection of products to a user (1302), and receive preference inputs from a user (1303). In some embodiments, the system 100 prompts a user to provide feedback on specific visual product features (such as shoe segment) and receives positive and negative feedback (1305) as inputs from the user, such as “I like it” or “I don't want it.” Once the system 100 receives this feedback, it correlates the feedback to visual characteristics. In the illustrated embodiment, the system 100 is receiving the feedback (1305) from the user in response to visual aspects of sneakers and determining a correlation score for other products based on the feedback. In the procedure depicted in FIG. 13, the user is providing negative feedback for the toe design 1307 of Shoe A and positive feedback for the toe design 1309 of Shoe B. The depicted procedure is receiving positive feedback for top design 1311 of Shoe B and negative feedback for top design 1313 of Shoe C. The depicted procedure is receiving positive feedback for sole design 1315 of Shoe A and negative feedback for sole design 1317 of Shoe B and sole design 1319 of Shoe C. Upon receiving these inputs, the system 100 is operable in some embodiments to correlate the feedback to an existing dataset. In the illustrated embodiment, the system 100 determines that Shoe D 1321 includes features most similar to each of the visual aspects identified with positive feedback in the prompted product set, since it matches a sole, toe, and top design that the user had identified with positive feedback.

In some embodiments, the system 100 is operable to automatically or manually assign a numerical value to each visual aspect of a shoe. In some automatic embodiments, the system weights each input from a user equally. For example, if a user provides feedback on three different visual characteristics of a product, each of those visual characteristics are weighted equally. In some embodiments, this means that a product from a product dataset that matches two out of three of the inputs from the user would have a score of 0.67. If a product matched all the inputs from the user, the product would have a score of 1.00. In some embodiments, the score is adjusted based on a visual confidence interval. For example, if the system 100 receives a positive input for a sole design, but a product in the dataset includes a sole design that is close but not exactly the same as the design that received a positive review, the system 100 is operable to increase or decrease a correlation score based on a set value, a percentage value, or a statistical value corresponding to a confidence interval or standard deviation representing similarity between the designs. In some embodiments, the system 100 is operable to use a visual plugin that provides image correlation and matching via statistical algorithms. In some embodiments, the system 100 is operable to automatically or manually set visual product characteristic categories based on comparing product images to find similarities or differences. For example, based on a comparison, the system 100 is operable to recognize features in an image and create classification categories corresponding to sole designs, toe designs, and top designs and present those categories to a user during training. In some embodiments, classification categories corresponding to visual features are manually set by a user. In some embodiments, the system 100 is operable to receive and store manual regions corresponding to a product visualization (e.g., pixels or regions of a product image) corresponding to the classification categories.

In some manual embodiments, the system 100 is operable to receive inputs from a user indicating set weights for each category. For example, in a shoe product embodiment, the system 100 is operable to receive a desired weight of 40% for a sole design, 30% for a toe design, and 30% for a top design. When the system 100 determines a correlation score for a product, it is then configured to weight each feature accordingly before making a recommendation. For example, a product that would have had a score of 0.67 in an equally weighted embodiment (for matching only sole design and toe design but not top design) would instead have a score of 0.70 (0.40+0.30). In some embodiments, the weighting is determined automatically based on determined user preferences. For example, based on previous interactions with the system 100 and previous sales conversions, the system 100 is operable to determine which features are the most determinative in converting a sale, and it is operable to weight those features accordingly. This is advantageous, because some products may have higher probabilities for some categories than others. For example, a camera product may include a high score of 0.89 for sport photography but a low score of 0.04 for low-light performance.

In some embodiments, the system 100 is in network communication with one or more websites, databases, and/or other source of product reviews. The system 100 is further operable to load, scrape, and/or otherwise retrieve reviews for processing. In some embodiments, the system 100 is operable to store and/or classify reviews based on a review type or attribute. For example, in some embodiments, a type or attribute includes an indication if the review is from an expert or a consumer, or it includes an indication of whether the review is verified or unverified. In some embodiments, the system 100 is operable to analyze the reviews, based on the type or attribute, and adjust a training model and/or provide key statements or recommendations that incorporate the type or attribute. For example, in some embodiments, the system 100 is operable to determine that a specific expert review is more effective in inducing a purchase to consumers, and based on a product's relevancy, the system 100 is operable to provide a key statement or description, similar as the description depicted in FIG. 2A.

In some embodiments, the system 100 further includes a natural language processing (NLP) engine which ingests and classifies raw text associated with one or more products. The system 100 is operable to use the NLP engine independently or follows classification via the human-aided classification engine and/or visual classification engine. This advantageously allows for the system 100 to correlate terms, sentiments, references, and statements with a score associated with one or more previous models.

FIG. 14 illustrates a diagram of an NLP training engine according to an embodiment. More particularly, FIG. 14 illustrates an NLP engine and natural language classification operation, wherein the system 100 receives reviews (1401, 1403) as inputs, and wherein the system 100 is operable to extract keywords 1405 from the reviews (1401, 1403). In the illustrated embodiment, the system 100 is receiving at least two reviews (1401, 1403) for a refrigerator product. The NLP engine is operable to determine that the first review 1401 is negative and the second review 1403 is positive based on semantic analysis and semantic indicators of the input text of the reviews (1401, 1403). Further, the NLP engine is operable to determine a sentiment of specific terms. For example, in the illustrated embodiment, the NLP engine determines a sentiment factor connected to the term “ice maker.” Because the term is used in positive reviews 82% of the time, the positive sentiment factor 1405 of the ice maker is 82%. Related terms 1407 to “ice maker” are also recognized and attached by the NLP engine, including “dispenser,” “quiet,” and “lots of space.” These terms are captured and stored by the system in a memory for model training and future access.

In some embodiments, the sentiment categories are Positive, Negative, Neutral, and Mixed. In some embodiments, the sentiment categories are nondiscrete, wherein the NLP engine is operable to classify a term or review as positive or negative on a continuous scale. For example, in some embodiments, the NLP engine is operable to determine a first review has a positive sentiment of 60%. The NLP engine is further operable to include additional sentiment factors that are either joint or separate. For example, the NLP engine is operable to assign as a second review a positive sentiment factor of 60% and a negative sentiment factor of 55%, wherein each of the sentiment factors corresponds to how confident or how strong the language in the review is attached to a particular sentiment. In some embodiments, these sentiments are combined to determine an overall sentiment factor that is categorical (i.e., “Positive”) and/or numerical (i.e., “89% positive”).

FIG. 15 illustrates a visualization of an NLP classification according to an embodiment. More particularly, FIG. 15 illustrates a graphical interface for an NLP engine, wherein the system 100 is operable to display the graphical interface on a screen or device in network communication with the system 100. In the illustrated embodiment, the graphical interface includes an output reflecting the functionality of the NLP engine. The interface displays descriptors and analytics stored with and calculated by the system 100 for a particular product. In this case, the NLP engine has received textual inputs and has extracted keywords from the textual inputs. For example, the NLP engine has determined common needs of users (1501) (e.g., size, ingredients, colorful, etc.) and various specific search criteria that users use (e.g., compact to fit in small spaces, too expensive, waterproof, etc.). In addition, the NLP engine has classified authors of the textual inputs into segments. In some embodiments, the NLP engine is operable to use textual analysis to classify authors into segments in a Segments portion of the display (1503). Segments include categories that are quantitative or qualitative. For example, segments include, in some embodiments, a “frequent commenter” segment for an author who submits more than a threshold of online comments, a “content generator” segment for an author whose interactions frequently lead to engagement by other authors, or a “new user” segment for authors who have not provided many textual inputs in the past. In some embodiments, the segments are based on textual semantic textual analysis. For example, an “Advocate” sector is applied in some embodiments to authors contributing textual inputs with high detected emotional language. The system 100 is operable to automatically determine or manually receive classification categories for semantic correlation. For example, the system 100 is operable to receive a “complex vocabulary” of desired features, and the system 100 is operable to classify each of the authors and/or textual inputs based on the complex vocabulary input. In addition, the system 100 is operable to automatically recognize and classify authors and/or textual inputs based on determined similar textual and/or semantic language.

In some embodiments, the system 100 is operable to extract, exclude, and/or interpret statements that require more complex analysis. For example, in some embodiments, the model is operable to first receive textual inputs and filter the textual inputs based on a semantics engine. For example, if a statement reads, “This product is not ideal for outdoor use,” the system 100 is operable to relate the statement to classification for both indoor and outdoor use by increasing or decreasing a weight of correlation between the product and the classification. In some embodiments, the system 100 is further operable to filter sarcastic statements and ambiguous statements which do not effectively aid in classification. For example, in some embodiments, the system 100 uses a semantics engine to filter out statements such as “This product is wicked,” or “I'd buy this product for my enemy but not my friend.” In some embodiments, the system 100 is operable to identify certain brands that are related to the common needs or search criteria based on certain information, such as information from a company's website, and determine a percentage of the relation for each brand. Moreover, in other embodiments, the system 100 is operable to determine the positive or negative feedback for the determined brands by sifting through certain information, such as customer reviews.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as exemplary only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (“GUI”), among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

1. A system for providing information to a customer to increase a likelihood of a purchase, the system comprising:
at least one processor programmed to:
receive at least one response from the customer;
analyze the at least one response to determine contextual information associated with the at least one response;
access a database to select a product category identifier based on the contextual information;
analyze, using a model, the contextual information and the product category identifier to generate a plurality of outputs, wherein the model is configured to apply one or more weights to the contextual information and the product category identifier;
select one of the plurality of outputs; and
provide the selected output to the customer.

2. The system of claim 1, further comprising the at least one processor programmed to: after generating a plurality of outputs, assigning a confidence value for each generated output.

3. The system of claim 2, wherein the selecting one of the plurality of outputs comprises selecting the plurality of outputs based on the assigned confidence values.

4. The system of claim 3, wherein the selecting one of the plurality of outputs comprises selecting the output with the second highest confidence value.

5. The system of claim 1, wherein the selecting one of the plurality of outputs comprises selecting the plurality of outputs based on a randomness alpha variable.

6. The system of claim 1, wherein the at least one response is received after providing an inquiry to the customer.

7. The system of claim 1, wherein the at least one response is received from the customer via an online portal.

8. The system of claim 1, wherein the contextual information includes information identifying at least one of a product or a product category.

9. The system of claim 1,
wherein using the model comprises predicting a likelihood of the customer purchasing a product related to the product category identifier,
wherein, when the likelihood equals or exceeds a target threshold, determine an optimal target product related to the product category identifier;
wherein, when the optimal target product is determined, the selecting one of the plurality of outputs comprises providing an output to the customer describing the optimal target product.

10. The system of claim 1, wherein the contextual information includes one or more of the following:
(a) environmental factors including time, date, or location;
(b) parameters relating to the customer including customer behavior, customer demographics, and previous customer responses;
(c) parameters relating to other customers including customer behavior of the other customers, demographics of the other customers, and previous responses from the other customers;
(d) stored product information including but not limited to inventory data and product trend data; or
(e) response data extracted based on the content provided in the one or more responses.

11. The system of claim 1, wherein the using a model comprises applying a modified q-learning algorithm.

12. The system of claim 1, wherein providing the selected output comprises providing the selected output in under 200 milliseconds from receipt of the at least one response.

13. The system of claim 1,
wherein the generated plurality of outputs include one or more of: (i) a predetermined response stored in the database, (ii) a modified-version of a predetermined response generated based on the analysis of the contextual information, or (iii) a newly generated response that is not based on a predetermined response and is based on the analysis of the contextual information.

14. The system of claim 1, wherein the generated plurality of outputs includes a text-based response, an image-based response, or a response with both text and images.

15. The system of claim 1, wherein providing the selected output comprises presenting the output on at least a portion of a graphical user interface on a device.

16. The system of claim 15, wherein the portion of the graphical user interface used to present the output is dynamically altered based on customer actions taken on the graphical user interface.

17. A method for providing information to a customer to increase a likelihood of a purchase, the method comprising:
receiving at least one response from the customer;
analyzing the at least one response to determine contextual information associated with the at least one response;
accessing a database to select a product category identifier based on the contextual information;
analyzing, using a model, the contextual information and the product category identifier to generate a plurality of outputs, wherein the model is configured to apply one or more weights to the contextual information and the product category identifier;
selecting one of the plurality of outputs; and
providing the selected output to the customer.

18. The method of claim 17, further comprising:
after generating a plurality of outputs, assigning a confidence value for each generated output;
wherein the selecting one of the plurality of outputs comprises selecting the plurality of outputs based on the assigned confidence values;
wherein the selecting one of the plurality of outputs comprises selecting the output with the second highest confidence value.

19. A non-transitory computer-readable storage medium storing instructions that, when executed by at least one processor, cause the at least one processor to perform a method for providing information to a customer to increase a likelihood of a purchase, the method comprising:
receiving at least one response from the customer;
analyzing the at least one response to determine contextual information associated with the at least one response;
accessing a database to select a product category identifier based on the contextual information;
analyzing, using a model, the contextual information and the product category identifier to generate a plurality of outputs, wherein the model is configured to apply one or more weights to the contextual information and the product category identifier;
selecting one of the plurality of outputs; and
providing the selected output to the customer.

20. The non-transitory computer-readable storage medium of claim 19, wherein the method further comprises:
after generating a plurality of outputs, assigning a confidence value for each generated output;
wherein the selecting one of the plurality of outputs comprises selecting the plurality of outputs based on the assigned confidence values;
wherein the selecting one of the plurality of outputs comprises selecting the output with the second highest confidence value.
